(19) United States
(12) Patent Application Publication
(10) Pub. No.: US 2004/0107820 A1
(43) Pub. Date: Jun. 10, 2004

(54) SUPPORT STRUCTURE FOR DRUM

(76) Inventor: Chun-Cheng Chen, Taichung (TW)

Correspondence Address: Chun-Cheng Chen, 58, MA YUAN WEST ST., TAICHUNG, TW

(21) Appl. No.: 10/314,781

(22) Filed: Dec. 6, 2002

(51) Int. Cl. G10D 13/02

(52) U.S. Cl. 84/421

(57) ABSTRACT

A support structure for a drum includes a fixing seat, a combination seat, two displacement seats, two connecting tubes, two links, two universal connectors, two connecting seats, and two foot pads. Each of the two links and the respective connecting tube form the foot post of the support structure. Thus, the inclined angle of each of the two foot posts relative to the combination seat is arbitrarily adjusted rapidly, easily and conveniently, thereby facilitating the user using the support structure.

### BACKGROUND OF THE INVENTION

1. Field of the Invention

The present invention relates to a support structure for a drum, and more particularly to a support structure for a drum, wherein the inclined angle of each of the two foot posts relative to the combination seat is arbitrarily adjusted rapidly, easily and conveniently, thereby facilitating the user using the support structure.

2. Description of the Related Art

A conventional support structure for a drum in accordance with the prior art shown in FIGS. 1 and 2 is mounted on each of two sides of a drum 90 and comprises a fixing seat 10A, a combination seat 13A, and a foot post 18A. The fixing seat 10A is locked on a frame 92 of the drum 90. The fixing seat 10A is formed with a through hole 11A. The combination seat 13A is secured on the fixing seat 10A. The combination seat 13A has a first side formed with an engaging portion 14A and a through hole 15A. The combination seat 13A has a second side formed with a receiving hole 16A and a connecting hole 17A. A bolt 1A is extended through a washer 2A, the inner side of the frame 92 of the drum 90, the through hole 11A of the fixing seat 10A and the through hole 15A of the combination seat 13A, and is screwed with a wing nut 3A, thereby securing the combination seat 13A on the fixing seat 10A. The foot post 18A has one end received in the receiving hole 16A of the combination seat 13A and formed with a connecting hole 19A. A pin 4A is extended through the connecting hole 17A of the combination seat 13A and is riveted in the connecting hole 19A of the foot post 18A, thereby securing the foot post 18A on the combination seat 13A. When the bolt 1A is unscrewed from the wing nut 3A, the combination seat 13A is pivoted relative to the fixing seat 10A, thereby adjusting the inclined angle of the foot post 18 relative to the fixing seat 10A and the drum 90. However, the inclined angle of the foot post 18 relative to the fixing seat 10A and the drum 90 cannot be adjusted easily and conveniently, thereby causing inconvenience to the user. In addition, the foot post 18 mounted on each of the two sides of the drum 90 cannot support the drum 90 rigidly and stably, thereby affecting operation of the drum 90.

### SUMMARY OF THE INVENTION

The present invention has arisen to mitigate and/or obviate the disadvantage of the conventional support structure for a drum.

The primary objective of the present invention is to provide a support structure for a drum, wherein the inclined angle of each of the two foot posts relative to the combination seat is arbitrarily adjusted rapidly, easily and conveniently, thereby facilitating the user using the support structure.

Another objective of the present invention is to provide a support structure for a drum, wherein the convex toothed portion of each of the two displacement seats is engaged with a respective one of the two concave toothed portions of the combination seat, so that each of the two displacement seats is positioned on the combination seat rigidly and stably.

A further objective of the present invention is to provide a support structure for a drum, wherein the inclined angle of each of the two foot pads relative to the respective foot post is arbitrarily adjusted rapidly, easily and conveniently, thereby facilitating the user using the support structure.

In accordance with the present invention, there is provided a support structure for a drum, comprising a combination seat, two displacement seats, two connecting tubes, two links, two universal connectors, two connecting seats, and two foot pads, wherein:

the combination seat has a first side and a second side;

each of the two displacement seats is pivotally mounted on the combination seat and has a first end formed with a receiving hole and a second end pivotally mounted on the second side of the combination seat;

each of the two connecting tubes is secured on a respective one of the two displacement seats and has a first end received in the receiving hole of the respective displacement seat;

each of the two links is secured on a respective one of the two connecting tubes and has a first end inserted into a second end of the respective connecting tube and a second end formed with an inner screw bore;

each of the two universal connectors is mounted on a respective one of the two links and includes a support seat and a rocking rod rotatably mounted on the support seat, the support seat of each of the two universal connectors has a top face formed with a cone-shaped chamber and a bottom face formed with a screw bore;

each of the two connecting seats is mounted on a respective one of the two universal connectors and has a top formed with a protruding receiving portion for receiving the support seat of the respective universal connector, each of the two connecting seats is formed with a through hole aligning with the screw bore of the support seat of the respective universal connector; and

each of the two foot pads is mounted in a respective one of the two connecting seats and has a top formed with an insertion portion inserted into the respective connecting seat and a bottom formed with an anti-skid portion.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a conventional support structure for a drum in accordance with the prior art;

FIG. 2 is an exploded perspective view of the conventional support structure for a drum in accordance with the prior art;

FIG. 3 is a partially exploded perspective view of a support structure for a drum in accordance with a first embodiment of the present invention;

FIG. 3A is a partially enlarged view of a displacement seat of the support structure for a drum as shown in FIG. 3;

FIG. 4 is a perspective assembly view of the support structure for a drum in accordance with the first embodiment of the present invention;

FIG. 5 is a side plan cross-sectional assembly view of the support structure for a drum in accordance with the first embodiment of the present invention;

FIG. 6 is a plan operational view of the support structure for a drum as shown in FIG. 4;

FIG. 7 is a plan operational view of the support structure for a drum as shown in FIG. 4;

FIG. 8 is a partially exploded perspective view of a support structure for a drum in accordance with a second embodiment of the present invention;

FIG. 9 is a partially exploded perspective view of a support structure for a drum in accordance with a third embodiment of the present invention;

FIG. 10 is a side plan cross-sectional assembly view of the support structure for a drum in accordance with the third embodiment of the present invention;

FIG. 11 is a partially exploded perspective view of a support structure for a drum in accordance with a fourth embodiment of the present invention;

FIG. 12 is a side plan cross-sectional assembly view of the support structure for a drum in accordance with the fourth embodiment of the present invention;

FIG. 13 is a partially exploded perspective view of a support structure for a drum in accordance with a fifth embodiment of the present invention; and

FIG. 13A is a partially enlarged view of a displacement seat of the support structure for a drum as shown in FIG. 13.

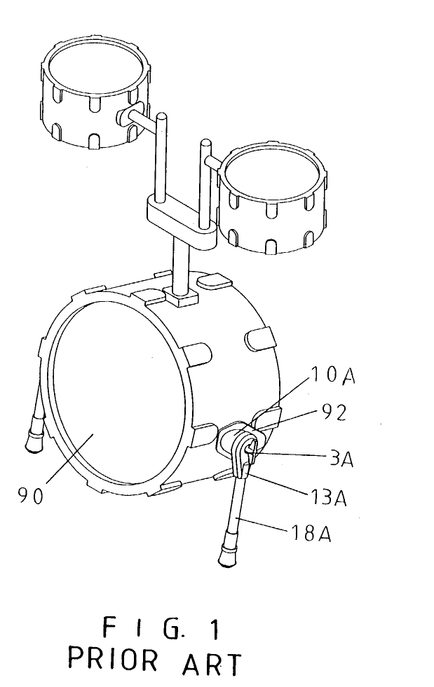

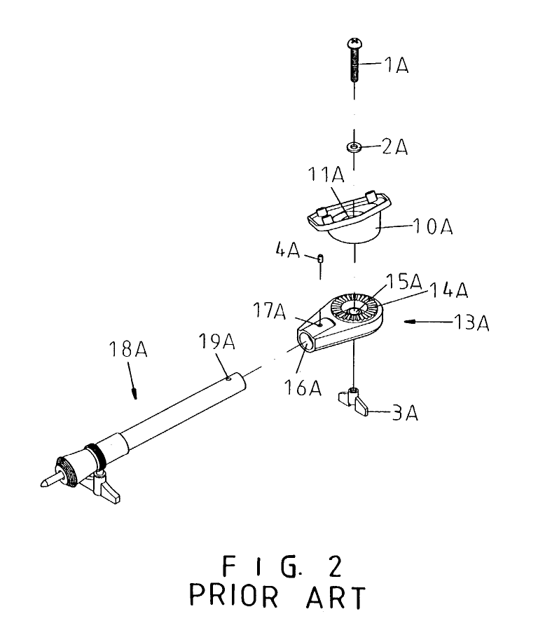

### DETAILED DESCRIPTION OF THE INVENTION

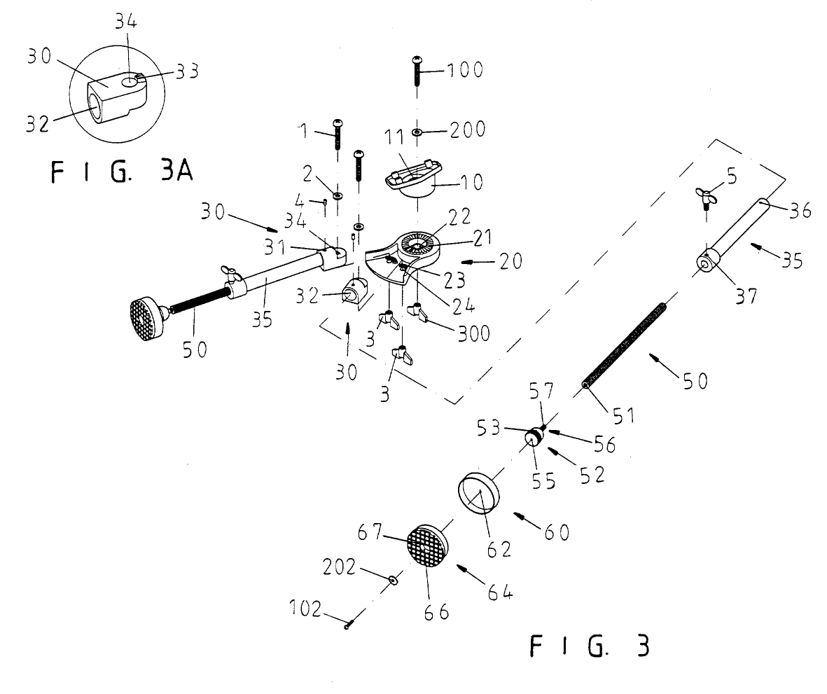

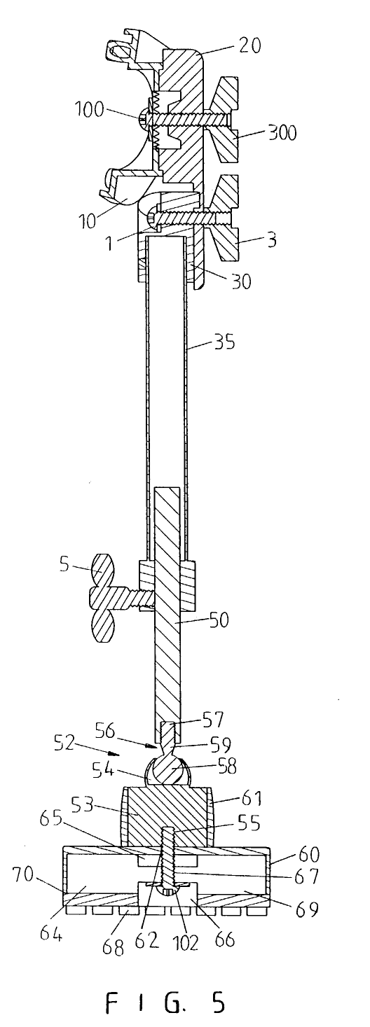

Referring to the drawings and initially to FIGS. 3-7, a support structure for a drum in accordance with a first embodiment of the present invention comprises a fixing seat 10, a combination seat 20, two displacement seats 30, two connecting tubes 35, two links 50, two universal connectors 52, two connecting seats 60, and two foot pads 64.

The fixing seat 10 is locked on a frame (not shown) of a drum (not shown). The fixing seat 10 is formed with a through hole 11.

The combination seat 20 is secured on the fixing seat 10. The combination seat 20 has a first side formed with a circular protruding engaging portion 21 and formed with a through hole 22. The combination seat 20 has a second side formed with two spaced sector-shaped concave toothed portions 23 and two spaced through holes 24.

A bolt 100 is extended through a washer 200, the inner side of the frame of the drum, the through hole 11 of the fixing seat 10 and the through hole 22 of the combination seat 20, and is screwed with a wing nut 300, thereby securing the combination seat 20 on the fixing seat 10.

Each of the two displacement seats 30 is pivotally mounted on the second side of the combination seat 20. Each of the two displacement seats 30 has a first end formed with a receiving hole 32 and a connecting hole 31 communicating with the receiving hole 32 and a second end formed with a sector-shaped convex toothed portion 33 engaged with a respective one of the two concave toothed portions 23 of the combination seat 20 and formed with a through hole 34 aligning with a respective one of the two through holes 24 of the combination seat 20.

The support structure of the present invention further comprises two bolts 1 each extended through a washer 2, the through hole 34 of a respective one of the two displacement seats 30 and a respective one of the two through holes 24 of the combination seat 20, and is screwed with a respective one of two wing nuts 3, thereby securing each of the two displacement seats 30 on the combination seat 20.

Each of the two connecting tubes 35 is secured on a respective one of the two displacement seats 30. Each of the two connecting tubes 35 has a first end received in the receiving hole 32 of the respective displacement seat 30 and formed with a connecting hole 36 aligning with the connecting hole 31 of the respective displacement seat 30. The support structure of the present invention further comprises two insertion pins 4 each extended through the connecting hole 31 of a respective one of the two displacement seats 30 and each secured in the connecting hole 36 of a respective one of the two connecting tubes 35 by riveting, so that each of the two connecting tubes 35 is combined with the respective displacement seat 30 integrally. Each of the two connecting tubes 35 has a second end formed with a threaded locking hole 37.

Each of the two links 50 is a circular rod and is secured on a respective one of the two connecting tubes 35. Each of the two links 50 has a first end inserted into the second end of the respective connecting tube 35. The support structure of the present invention further comprises two wing-shaped bolts 5 each screwed into the threaded locking hole 37 of a respective one of the two connecting tubes 35 and each urged on the first end of a respective one of the two links 50. Each of the two links 50 has a second end formed with an inner screw bore 51.

Each of the two links 50 and the respective connecting tube 35 form the foot post 18 of the support structure of the present invention.

Each of the two universal connectors 52 is mounted on a respective one of the two links 50, and includes, a support seat 53 and a rocking rod 56 rotatably mounted on the support seat 53. The support seat 53 of each of the two universal connectors 52 has a top face formed with a cone-shaped chamber 54 and a bottom face formed with a screw bore 55. The rocking rod 56 of each of the two universal connectors 52 has a first end formed with a threaded rod 57 screwed into the inner screw bore 51 of the respective link 50 and a second end formed with a spherical head 58 pivotally mounted in the chamber 54 of the support seat 53. The rocking rod 56 of each of the two universal connectors 52 has a mediate portion formed with a reduced neck 59 connecting the threaded rod 57 and the spherical head 58.

Each of the two connecting seats 60 is mounted on a respective one of the two universal connectors 52. Each of the two connecting seats 60 has a top formed with a protruding receiving portion 61 for receiving the support seat 53 of the respective universal connector 52. Each of the two connecting seats 60 is formed with a through hole 62 aligning with the screw bore 55 of the support seat 53 of the respective universal connector 52.

Each of the two foot pads 64 is mounted in a respective one of the two connecting seats 60. Each of the two foot pads 64 has a top formed with an insertion portion 69 inserted into the respective connecting seat 60 and a bottom formed with an anti-skid portion 68. Each of the two foot pads 64 has a mediate portion formed with a resting shoulder 70 rested on a bottom edge of the respective connecting seat 60. Each of the two foot pads 64 is formed with an upper chamber 65 and a lower chamber 66, and a through hole 67 communicating with the upper chamber 65 and the lower chamber 66.

The support structure of the present invention further comprises two bolts 102 each extended through a washer 202, the through hole 67 of a respective one of the two foot pads 64, the through hole 62 of a respective one of the two connecting seats 60, and screwed into the screw bore 55 of the support seat 53 of a respective one of the two universal connectors 52, thereby securing each of the two foot pads 64 and each of the two connecting seats 60 on the support seat 53 of the respective universal connector 52.

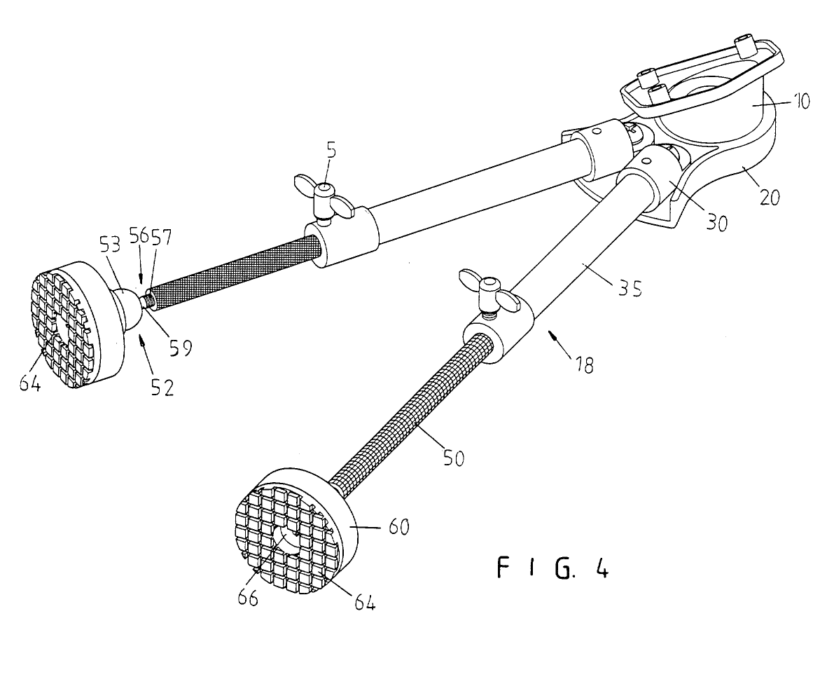

In operation, each of the two bolts 1 is extended through the washer 2, the through hole 34 of a respective one of the two displacement seats 30 and a respective one of the two through holes 24 of the combination seat 20, and is screwed with a respective one of two wing nuts 3, thereby securing each of the two displacement seats 30 on the combination seat 20. At this time, the convex toothed portion 33 of each of the two displacement seats 30 is engaged with a respective one of the two concave toothed portions 23 of the combination seat 20, so that each of the two displacement seats 30 is positioned on the combination seat 20 rigidly and stably as shown in FIG. 4.

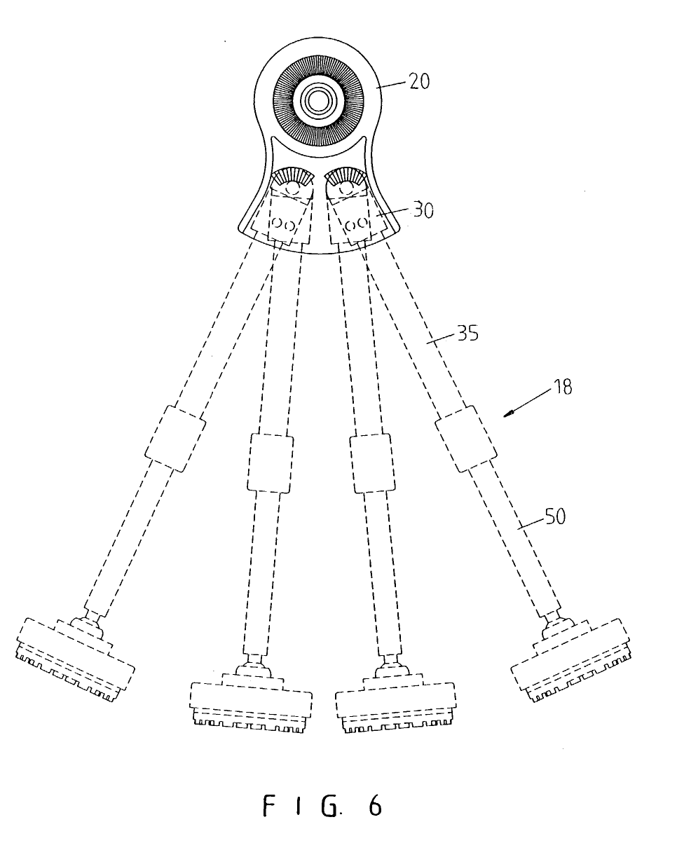

In adjustment of the inclined angle of each of the two foot posts 18 of the support structure of the present invention, each of the two bolts 1 is unscrewed from the respective wing nut 3, thereby disengaging the convex toothed portion 33 of each of the two displacement seats 30 from the respective concave toothed portion 23 of the combination seat 20, so that each of the two displacement seats 30 is pivoted relative to the combination seat 20 and each of the two foot posts 18 is pivoted relative to the combination seat 20 as shown in FIG. 6, thereby adjusting the inclined angle of each of the two foot posts 18 relative to the combination seat 20. Thus, the inclined angle of each of the two foot posts 18 relative to the combination seat 20 is arbitrarily adjusted rapidly, easily and conveniently as shown in FIG. 6, thereby facilitating the user using the support structure.

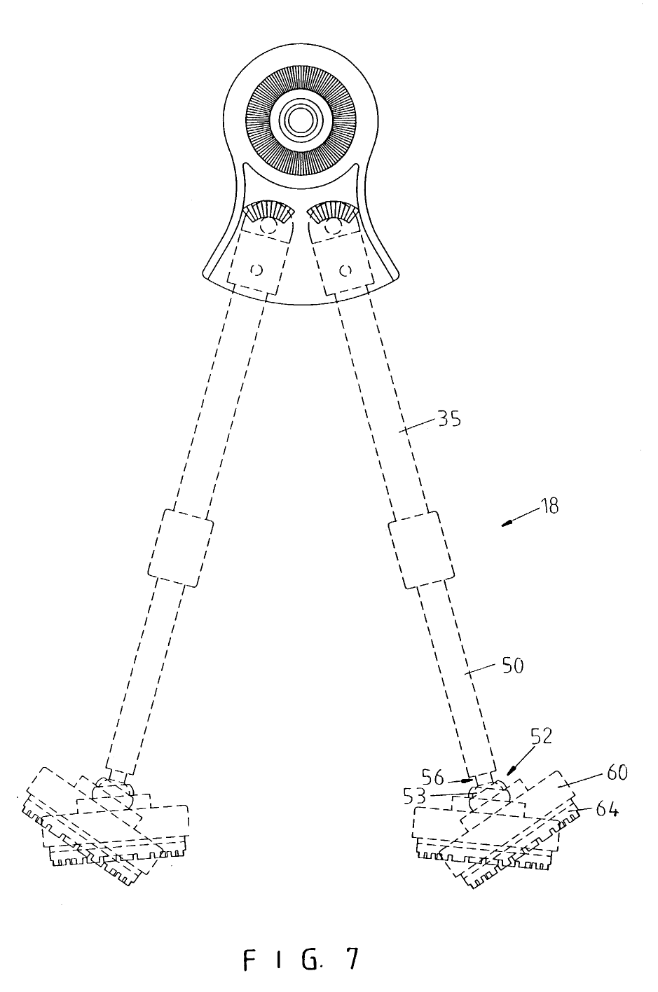

In addition, the rocking rod 56 of each of the two universal connectors 52 is rotatably mounted on the support seat 53, so that each of the two foot pads 64 and each of the two connecting seats 60 fixed on the support seat 53 of the respective universal connector 52 are pivoted relative to the respective link 50 that is fixed on the rocking rod 56 of the respective universal connector 52 as shown in FIG. 7, thereby adjusting the inclined angle of each of the two foot pads 64 relative to the respective link 50. Thus, the inclined angle of each of the two foot pads 64 relative to the link 50 of the respective foot post 18 is arbitrarily adjusted rapidly, easily and conveniently as shown in FIG. 7, thereby facilitating the user using the support structure.

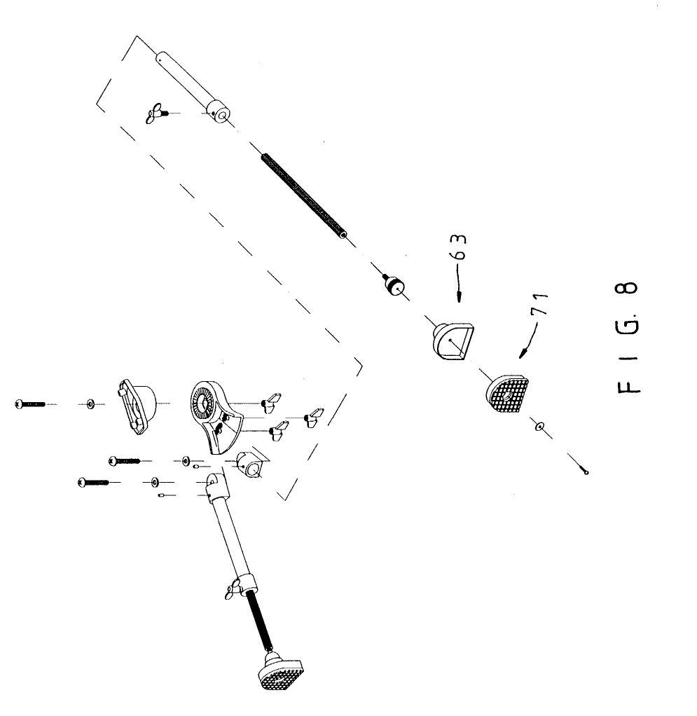

Referring to FIG. 8, the support structure for a drum in accordance with a second embodiment of the present invention is shown, wherein each of the two foot pads 71 has a horseshoe shape, and each of the two connecting seats has a horseshoe shape to mate with the configuration of the respective foot pad 71.

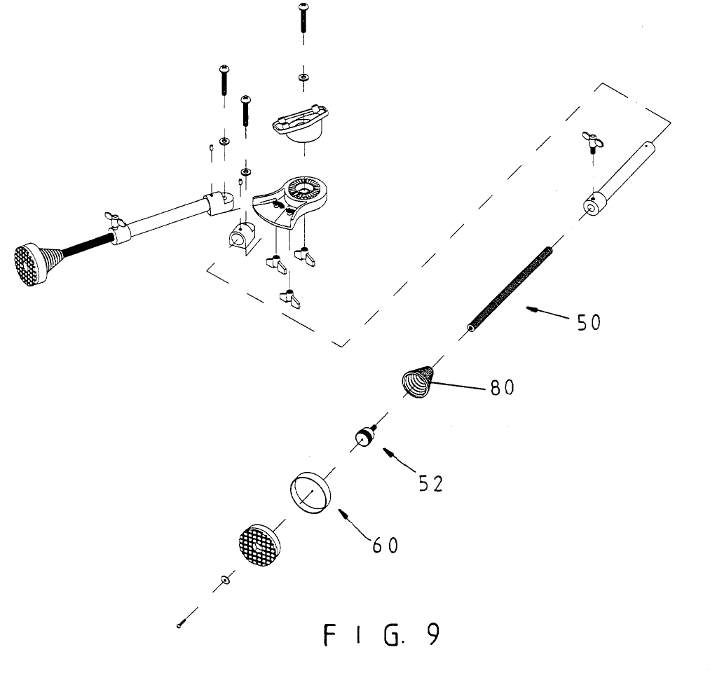

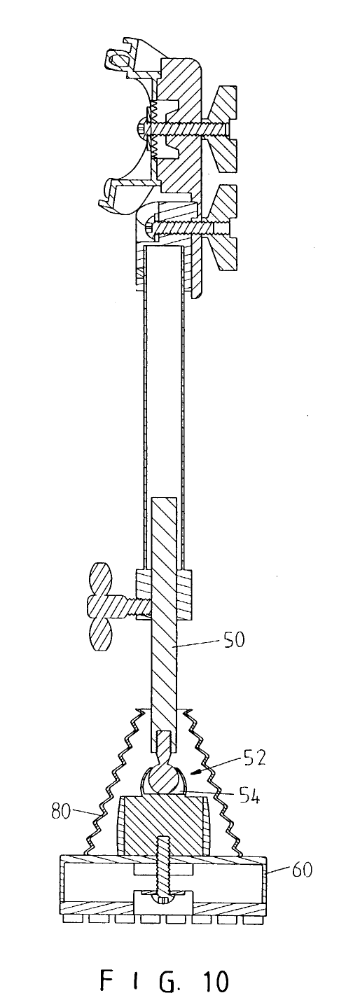

Referring to FIGS. 9 and 10, the support structure for a drum in accordance with a third embodiment of the present invention further comprises two covers 80 each mounted on a respective one of the two universal connectors 52 and each having a top end mounted on a respective one of the two links 50 and a bottom end mounted on a respective one of the two connecting seats 60, thereby preventing the dust from entering the chamber 54 of each of the two universal connectors 52, so as to protect each of the two universal connectors 52.

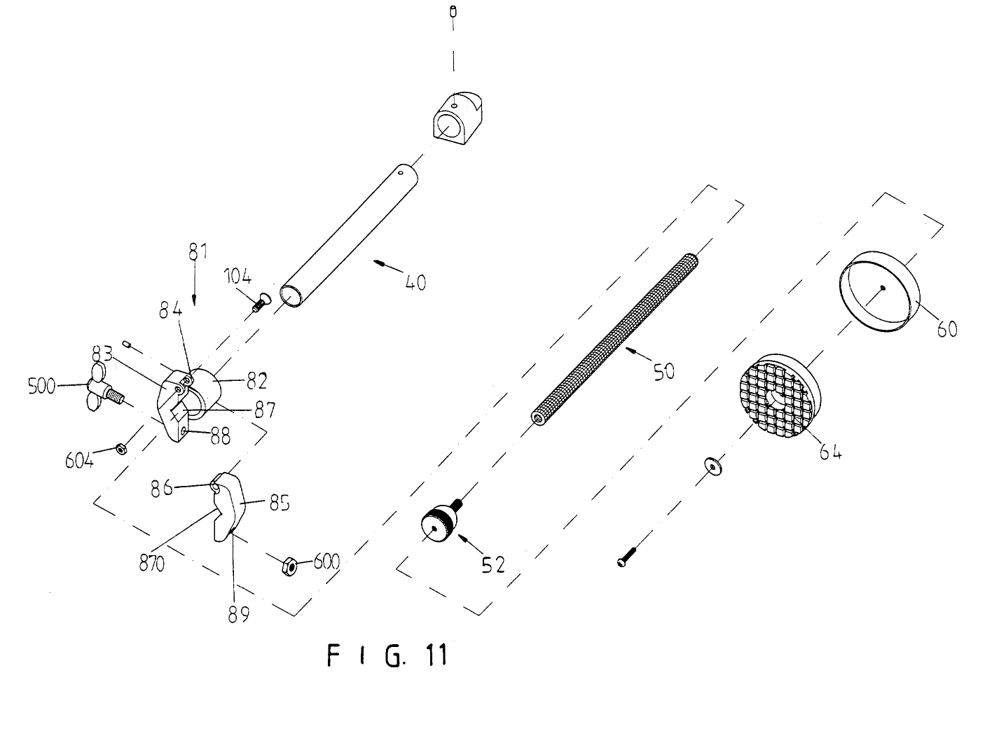

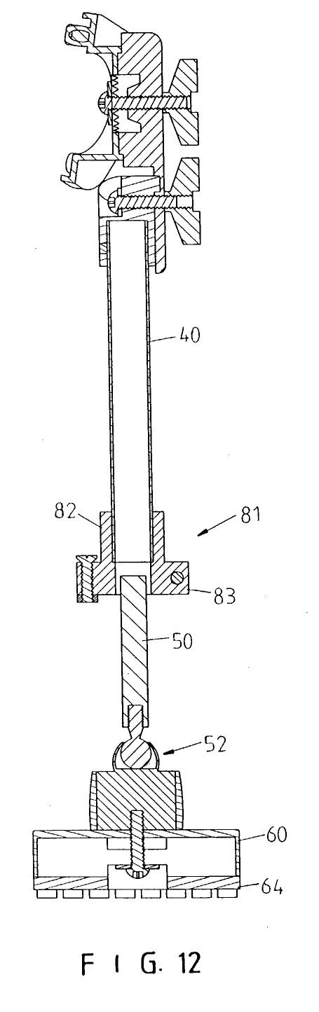

Referring to FIGS. 11 and 12, the support structure for a drum in accordance with a fourth embodiment of the present invention further comprises two pivot seats 81 each mounted between a respective one of the two connecting tubes 40 and a respective one of the two links 50.

Each of the two pivot seats 81 includes a mounting sleeve 82 mounted on the second end of the respective connecting tube 40, a bow-shaped fixing portion 83 integrally formed on the mounting sleeve 82, and a bow-shaped movable portion 85 pivotally mounted on the fixing portion 83.

The fixing portion 83 of each of the two pivot seats 81 has a first end formed with two spaced pivot ears 84. The movable portion 85 of each of the two pivot seats 81 has a first end formed with a rotation shaft 86 pivotally mounted between the two spaced pivot ears 84 of the fixing portion 83. The support structure of the present invention further comprises two bolts 104 each extended through the two spaced pivot ears 84 of the fixing portion 83 and the rotation shaft 86 of the movable portion 85, and screwed with a nut 604, so that the movable portion 85 is pivotally mounted on the fixing portion 83.

The fixing portion 83 of each of the two pivot seats 81 has a mediate portion formed with a clamping face 87, and the movable portion 85 of each of the two pivot seats 81 has a mediate portion formed with a clamping face 870, so that the first end of each of the links 50 is clamped between the clamping face 87 of the fixing portion 83 and the clamping face 870 of the movable portion 85.

The fixing portion 83 of each of the two pivot seats 81 has a second end formed with a through hole 88. The movable portion 85 of each of the two pivot seats 81 has a second end formed with a through hole 89. The support structure of the present invention further comprises two wing-shaped bolts 500 each extended through the through hole 88 of the fixing portion 83 and the through hole 89 of the movable portion 85, and screwed with a nut 600, so that the movable portion 85 is fixed on the fixing portion 83.

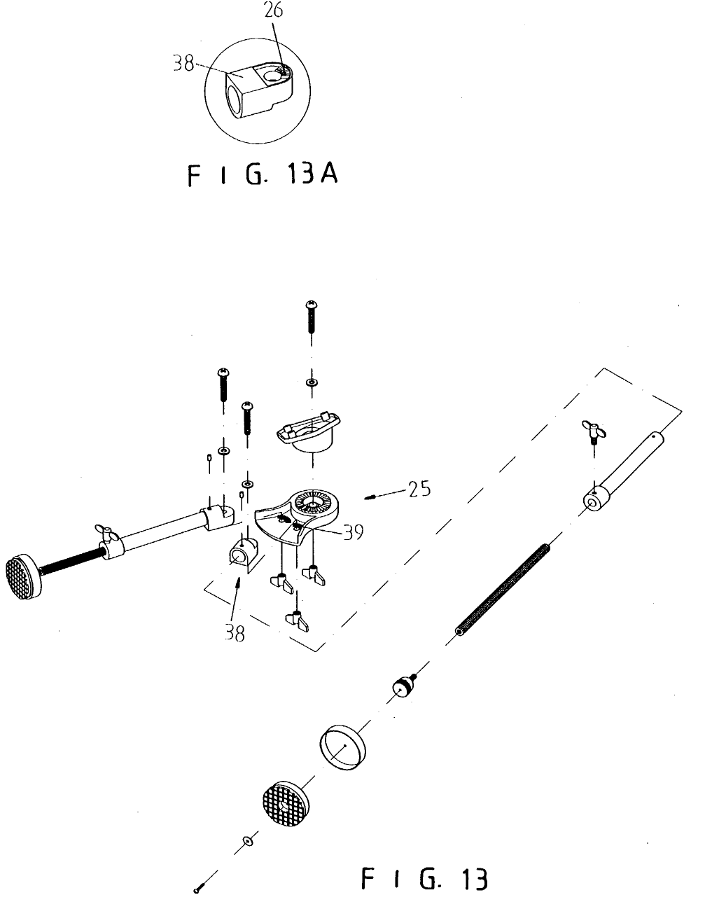

Referring to FIG. 13, the support structure for a drum in accordance with a fifth embodiment of the present invention is shown, wherein the second side of the combination seat 25 is formed with two spaced sector-shaped convex toothed portions 39, and the second end of each of the two displacement seats 38 is formed with a sector-shaped concave toothed portion 26 engaged with a respective one of the two convex toothed portions 39 of the combination seat 25.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A support structure for a drum, comprising a combination seat, two displacement seats, two connecting tubes, two links, two universal connectors, two connecting seats, and two foot pads, wherein:
the combination seat has a first side and a second side;
each of the two displacement seats is pivotally mounted on the combination seat and has a first end formed with a receiving hole and a second end pivotally mounted on the second side of the combination seat;
each of the two connecting tubes is secured on a respective one of the two displacement seats and has a first end received in the receiving hole of the respective displacement seat;
each of the two links is secured on a respective one of the two connecting tubes and has a first end inserted into a second end of the respective connecting tube and a second end formed with an inner screw bore;
each of the two universal connectors is mounted on a respective one of the two links and includes a support seat and a rocking rod rotatably mounted on the support seat, the support seat of each of the two universal connectors has a top face formed with a cone-shaped chamber and a bottom face formed with a screw bore;
each of the two connecting seats is mounted on a respective one of the two universal connectors and has a top formed with a protruding receiving portion for receiving the support seat of the respective universal connector, each of the two connecting seats is formed with a through hole aligning with the screw bore of the support seat of the respective universal connector; and
each of the two foot pads is mounted in a respective one of the two connecting seats and has a top formed with an insertion portion inserted into the respective connecting seat and a bottom formed with an anti-skid portion.

2. The support structure for a drum in accordance with claim 1, wherein the first side of the combination seat is formed with a circular protruding engaging portion and is formed with a through hole, and the support structure further comprises a fixing seat formed with a through hole, a bolt is extended through a washer, the through hole of the fixing seat and the through hole of the combination seat, and is screwed with a wing nut, thereby securing the combination seat on the fixing seat.

3. The support structure for a drum in accordance with claim 1, wherein the second side of the combination seat is formed with two spaced sector-shaped concave toothed portions, and the second end of each of the two displacement seats is formed with a sector-shaped convex toothed portion engaged with a respective one of the two concave toothed portions of the combination seat.

4. The support structure for a drum in accordance with claim 1, wherein the second side of the combination seat is formed with two spaced through holes, the second end of each of the two displacement seats is formed with a through hole aligning with a respective one of the two through holes of the combination seat, and the support structure further comprises two bolts each extended through a washer, the through hole of a respective one of the two displacement seats and a respective one of the two through holes of the combination seat, and is screwed with a respective one of two wing nuts, thereby securing each of the two displacement seats on the combination seat.

5. The support structure for a drum in accordance with claim 1, wherein the first end of each of the two displacement seats is formed with a connecting hole communicating with the receiving hole, the first end of each of the two connecting tubes is formed with a connecting hole aligning with the connecting hole of the respective displacement seat, and the support structure further comprises two insertion pins each extended through the connecting hole of a respective one of the two displacement seats and each secured in the connecting hole of a respective one of the two connecting tubes by riveting, so that each of the two connecting tubes is combined with the respective displacement seat integrally.

6. The support structure for a drum in accordance with claim 1, wherein the second end of each of the two connecting tubes is formed with a threaded locking hole, and the support structure further comprises two wing-shaped bolts each screwed into the threaded locking hole of a respective one of the two connecting tubes and each urged on the first end of a respective one of the two links.

7. The support structure for a drum in accordance with claim 1, wherein each of the two links and the respective connecting tube form the foot post of the support structure.

8. The support structure for a drum in accordance with claim 1, wherein the rocking rod of each of the two universal connectors has a first end formed with a threaded rod screwed into the inner screw bore of the respective link and a second end formed with a spherical head pivotally mounted in the chamber of the support seat, the rocking rod of each of the two universal connectors has a mediate portion formed with a reduced neck connecting the threaded rod and the spherical head.

9. The support structure for a drum in accordance with claim 1, wherein each of the two foot pads has a mediate portion formed with a resting shoulder rested on a bottom edge of the respective connecting seat.

10. The support structure for a drum in accordance with claim 1, wherein each of the two foot pads is formed with an upper chamber and a lower chamber, and a through hole communicating with the upper chamber and the lower chamber, and the support structure further comprises two bolts each extended through a washer, the through hole of a respective one of the two foot pads, the through hole of a respective one of the two connecting seats, and screwed into the screw bore of the support seat of a respective one of the two universal connectors, thereby securing each of the two foot pads and each of the two connecting seats on the support seat of the respective universal connector.

11. The support structure for a drum in accordance with claim 1, wherein each of the two foot pads has a horseshoe shape, and each of the two connecting seats has a horseshoe shape to mate with the configuration of the respective foot pad.

12. The support structure for a drum in accordance with claim 1, further comprising two covers each mounted on a respective one of the two universal connectors and each having a top end mounted on a respective one of the two links and a bottom end mounted on a respective one of the two connecting seats.

13. The support structure for a drum in accordance with claim 1, further comprising two pivot seats each mounted between a respective one of the two connecting tubes and a respective one of the two links, wherein each of the two pivot seats includes a mounting sleeve mounted on the second end of the respective connecting tube, a bow-shaped fixing portion integrally formed on the mounting sleeve, and a bow-shaped movable portion pivotally mounted on the fixing portion.

14. The support structure for a drum in accordance with claim 13, wherein the fixing portion of each of the two pivot seats has a first end formed with two spaced pivot ears, the movable portion of each of the two pivot seats has a first end formed with a rotation shaft pivotally mounted between the two spaced pivot ears of the fixing portion, and the support structure further comprises two bolts each extended through the two spaced pivot ears of the fixing portion and the rotation shaft of the movable portion, and screwed with a nut, so that the movable portion is pivotally mounted on the fixing portion.

15. The support structure for a drum in accordance with claim 13, wherein the fixing portion of each of the two pivot seats has a mediate portion formed with a clamping face, and the movable portion of each of the two pivot seats has a mediate portion formed with a clamping face, so that the first end of each of the links is clamped between the clamping face of the fixing portion and the clamping face of the movable portion.

16. The support structure for a drum in accordance with claim 13, wherein the fixing portion of each of the two pivot seats has a second end formed with a through hole, the movable portion of each of the two pivot seats has a second end formed with a through hole, and the support structure further comprises two wing-shaped bolts each extended through the through hole of the fixing portion and the through hole of the movable portion, and screwed with a nut, so that the movable portion is fixed on the fixing portion.

17. The support structure for a drum in accordance with claim 1, wherein the second side of the combination seat is formed with two spaced sector-shaped convex toothed portions, and the second end of each of the two displacement seats is formed with a sector-shaped concave toothed portion engaged with a respective one of the two convex toothed portions of the combination seat.
